(19) United States
(12) Patent Application Publication
(10) Pub. No.: US 2005/0051478 A1
(43) Pub. Date: Mar. 10, 2005

(54) Beverage filter cartridge

(76) Inventors: Basil Karanikos, Middleton, MA (US); Fredrick Rossi, Burlington, MA (US)

Correspondence Address: Attn: Maurice E. Gauthier;Samuels, Gauthier & Stevens, LLP, Suite 3300, 225 Franklin Street, Boston, MA, 02110, US

(21) Appl. No.: 10/658,925

(22) Filed: Sep. 10, 2003

(51) Int. Cl. B01D 35/00

(52) U.S. Cl. 210/469; 210/474; 210/477

(57) ABSTRACT

A beverage filter cartridge has an impermeable cup-shaped out container internally subdivided by a generally cup-shaped filter element into a first chamber inside the filter and a second chamber located between the filter bottom and the container bottom. The upper rim of the filter is joined at a peripheral juncture to the container side wall, and the filter side wall has exterior channels that face the container side wall and lead downwardly from the peripheral juncture to the second chamber.

### BACKGROUND OF THE INVENTION

1. Field of the Invention

This invention relates generally to single serve beverage brewing systems, and is concerned in particular with an improved filter cartridge for use in such systems.

2. Description of the Prior Art

In a known beverage filter cartridge of the type disclosed in U.S. Pat. Nos. 5,325,765 and 5,840,189, the cone-shaped filter element has a somewhat limited storage capacity for the beverage medium. Moreover, the configuration of the filter element encourages rapid liquid penetration to and through the lower end, resulting in less than optimum saturation of the beverage medium at upper regions of the filter element adjacent to the container wall. The combined effect of limited storage capacity and less than optimum saturation is a lowering of the total dissolved solids (“TDS”) in the brewed beverage, which translated into reduced flavor.

In an attempt at increasing the TDS of the resulting brew, and as shown in copending commonly owned U.S. patent application Ser. No. 09/782,622, beverage medium storage capacity was increased by lowering the level of attachment of the filter element to a reconfigured outer container wall. Although this did indeed increase the amount of beverage medium available for brewing, it did so at a cost of also increasing the amount of beverage medium receiving less that optimum saturation, with the net affect being an insignificant increase in TDS of the brewed beverage.

The present invention is directed to overcoming the drawbacks of the prior art by providing an improved combination of cartridge container and internal filter that achieves both increased storage capacity for the beverage medium, and optimized saturation, resulting in significantly increase TDS levels in the resulting brewed beverage.

### SUMMARY OF THE INVENTION

In accordance with the present invention, a beverage filter cartridge has an impermeable cup-shaped container with a bottom and a side wall diverging upwardly to a collar surrounding a top opening. A filter element has a substantially flat bottom and a side wall diverging upwardly to an upper rim. The said filter element is received in the container with its bottom spaced both inwardly from the container side wall and vertically from the container bottom, and with its upper rim joined at a peripheral juncture to the interior of the container side wall. The interior of the container is thus subdivided by the filter element into a first chamber accessible via the top container opening, and a second chamber disposed between the vertically spaced filter and container bottoms. The filter side wall has exterior channels that face the interior of the container side wall and that lead from the aforesaid peripheral juncture to the second chamber. A beverage medium is received in the first chamber via the container top opening, and an impermeable cover is sealed to the container collar. The cover is piercable to admit liquid into the first chamber for infusion with the beverage medium to produce a beverage, the filter element is permeable to accommodate a flow therethrough of the beverage for delivery via the exterior filter channels to the second chamber, and the container bottom is piercable to accommodate an outflow of the beverage from the cartridge. These and other features and advantages of the present invention will now be described in greater detail with reference to the accompanying drawings, wherein:

### BRIEF DESCRIPTION OF THE DRAWINGS

FIG. 1 is a vertical sectional view taken through a beverage filter cartridge in accordance with one embodiment of the present invention;

FIG. 2 is an exploded perspective view of the components of the filter cartridge;

FIG. 3 is a top plan view of the filter element;

FIG. 4 is a sectional view taken along line 4-4 of FIG. 1;

FIG. 5 is a perspective view of an alternative embodiment of a filter element;

FIG. 6 is a sectional view of the filter element shown in FIG. 5;

FIG. 7 is a top plan view of the filter element shown in FIG. 5;

FIG. 8 is a view similar to FIG. 1 showing the outer container pierced by inlet and outlet probes during a brewing cycle; and

FIG. 9 is another view similar to FIG. 1 showing a double-walled filter element.

### DETAILED DESCRIPTION OF PREFERRED EMBODIMENTS

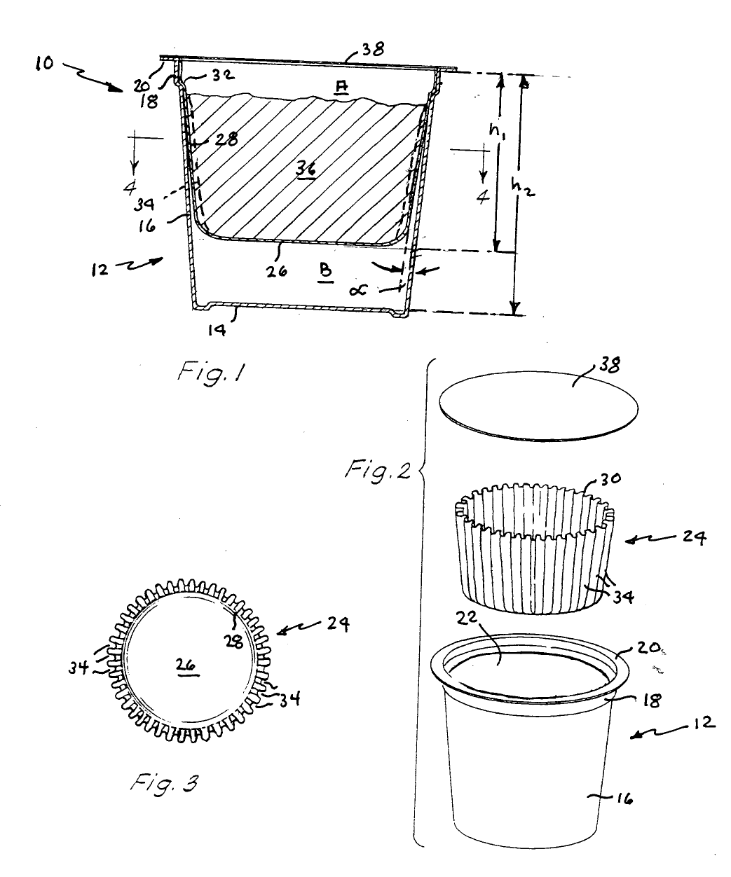

With reference initially to FIGS. 1-4, a beverage filter cartridge in accordance with one embodiment of the present invention is shown at 10. The cartridge includes an impermeable cup-shaped container 12 having a first bottom wall 14 and a first side wall 16 diverging upwardly to a collar 18 having a peripheral lip 20 surrounding a top opening 22.

As herein employed, the term “imperm eable” means substantially resistant to the passage therethrough of liquids and gases. The container 12 may be formed of any one of many commercially available materials, e.g., polystyrene, polyethylene, polypropylene, laminated composites thereof, etc. A filter element 24 has a substantially flat second bottom 26 and a second side wall 28 diverging upwardly to an upper rim 30. The filter element is permeable to liquids, and again may be formed from commercially available materials, e.g., paper or polymer materials. The filter element 24 is received in the container 12 with its bottom 26 spaced both inwardly from the container side wall 16 and vertically from the container bottom wall 14. The upper rim 30 of the filter is joined, as by heat sealing at a peripheral juncture 32, to the interior of the container side wall 16 in the vicinity of collar 18. When thus positioned, the filter element subdivides the interior of the container into a first chamber A accessible via the top opening 22 of the container, and a second chamber B disposed between the filter and container bottoms 26, 14.

The filter side wall 28 is configured to provide exterior channels indicated typically at 34 that face the interior of the container side wall 16 and that lead downwardly from the peripheral juncture 32 to the second chamber B. Preferably, the filter wall 28 is disposed at an angle of less than about 1° with respect to the container wall 16, with angles of between about 0.5 to 0.9° being preferable.

A beverage medium 36 is received in the first chamber A via the container top opening 22 and an impermeable cover 38 is joined as by heat sealing to the peripheral lip 20 of the container side wall 16. The cover may be formed of a plastic, metallic foil, or any laminated composite thereof. In accordance with conventional practice, oxygen may be purged from the container interior by the introduction of an inert gas, e.g., nitrogen, prior to sealing the cover in place.

The height h₁ of the first chamber A is between about 75 to 80% of the height h₂ of the cartridge interior. This, combined with the substantially flat filter bottom 26, maximizes the storage capacity for the beverage medium 36.

As shown in FIG. 8, during a brewing cycle, the cover 38 is pierced by a tubular inlet probe 40 to admit heated liquid into chamber A for infusion with the beverage medium to produce a liquid beverage. The permeability of the filter element 24 accommodates a flow therethrough of the beverage into the second chamber B. The channels 34 provide critical exit passageways for the beverage permeating through the filter side wall and in so doing encourage full saturation of the beverage medium in areas adjacent to the container side wall.

The container bottom 14 is pierced by a tubular outlet probe 42 to accommodate an outflow of the beverage from the cartridge. The vertical spacing of the filter bottom 26 from the container bottom 14 insures that the filter will be safeguarded from inadvertent puncture by the outlet probe 42.

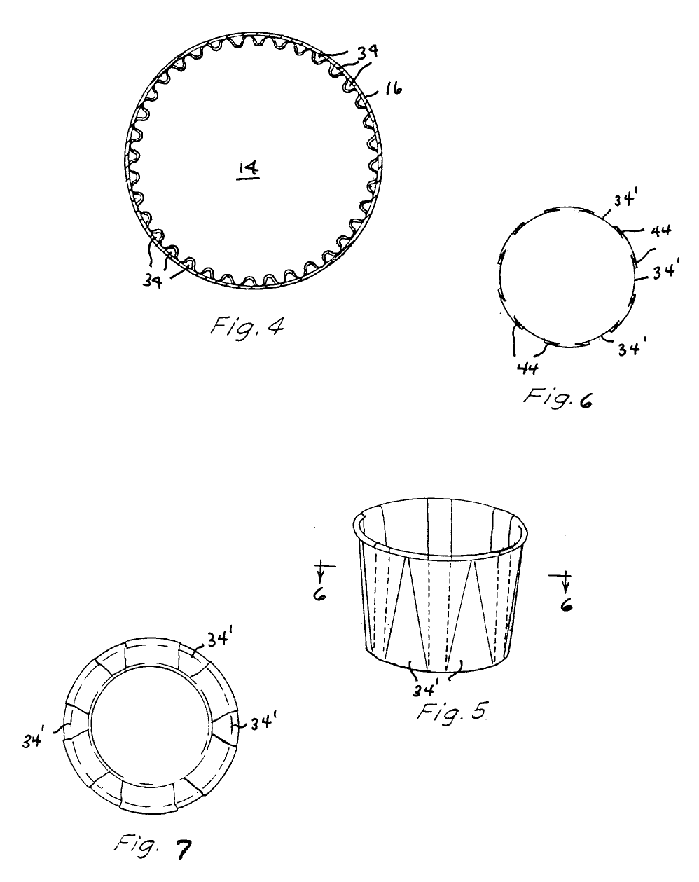

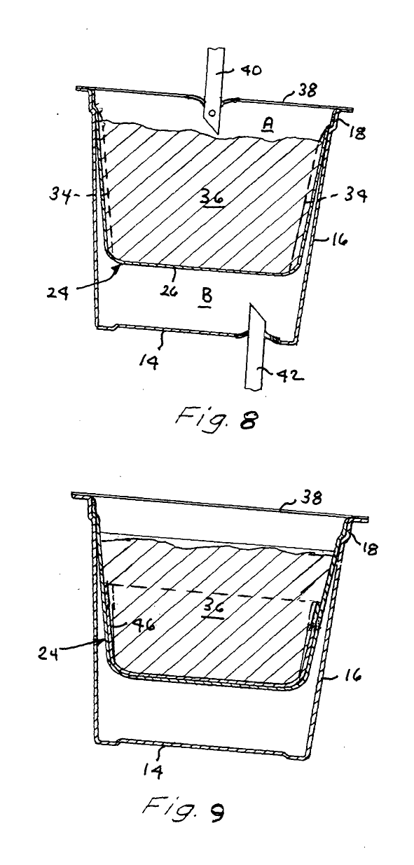

The channels 34 may be provided by forming the filter side wall with a fluted configuration as shown in FIGS. 1-4. Alternatively, as shown for example in FIGS. 5-7, channels 34 may be formed by pleats 44 in the filter side wall. When thus formed, the channels increase in width from a minimum at the upper rim of the filter to a maximum at the filter bottom.

While the above described fluted and pleated configurations of the filter side wall are considered to be preferable, any other configuration of the filter side wall and/or the container side wall providing exit channels and the like leading to the second chamber B would be acceptable, provided that they encourage through flow in upper regions of the filter wall.

Infusion of the beverage medium in the upper regions of the filter element may be further enhanced by decreasing the permeability of lower regions of the filter element. As shown in FIG. 9, this can be accomplished, for example, by providing the filter element with a complimentary shaped insert 46 of the same or like filter material. This will retard permeation of the beverage in the lower filter regions in favor of enhanced permeation in the upper regions adjacent to the container side wall.

Although the preceding description has been directed to specific embodiments of the invention, it will now be apparent to those skilled in the art that variations and modifications can be made with the attachment of some or all of the advantages of the invention. It is the objective of the appended claims to cover all such variation and modifications as come within the true spirit and scope of the invention.

1. A beverage filter cartridge comprising:
an impermeable cup-shaped container having a substantially flat first bottom and a first side wall diverging upwardly from said first bottom to a collar surrounding a top opening;
a filter element having a substantially flat second bottom and a second side wall diverging upwardly from said second bottom to an upper rim, said filter element being received in said container with said second bottom spaced both inwardly from said first side wall and vertically from said first bottom, and with said upper rim joined at a peripheral juncture to the interior of said first side wall, the interior of said container thus being subdivided by said filter element into a first chamber accessible via said top opening, and a second chamber disposed between said first and second bottoms, said second side wall coacting with the interior of said first side wall to define exit channels leading from said peripheral juncture to said second chamber;
a beverage medium received in said first chamber via said top opening; and
an impermeable cover sealed to said collar and closing said top opening, said cover being piercable to admit liquid into said first chamber for impulsion with said beverage medium to produce a beverage, said filter element being permeable to accommodate the flow therethrough of said beverage for delivery via said channels to said second chamber, and said first bottom being piercable to accommodate an outflow of said beverage from said cartridge.

2. The beverage filter cartridge of claim 1 wherein said first and second bottoms are substantially parallel.

3. The beverage filter cartridge of claim 1 wherein said channels are defined by flutes in said second side wall.

4. The beverage filter cartridge of claim 1 wherein said channels are defined by pleats in said second side wall.

5. The beverage filter cartridge of claim 1 wherein said second side wall extends downwardly from said peripheral juncture and away from said first side wall at an angle of less than about 1°.

6. The beverage filter cartridge of claim 5 wherein said angle is between about 0.50 to 0.90.

7. The beverage filter cartridge of claim 1 wherein the height of said first chamber is measured between said second bottoms and said cover is between about 75 to 80% of the height of the interior of said cartridge as measured between said first bottom and said cover.

8. The beverage filter cartridge of claim 4 wherein said channels increase in width from a minimum adjacent said peripheral juncture to a maximum at said second chamber.

9. The beverage filter cartridge of claim 1 wherein the permeability of a lower region of said filter element is reduced in comparison to the permeability of an upper region thereof.

10. The beverage filter cartridge of claim 9 wherein said reduced permeability is achieved by increasing the thickness of said filter element in said lower region.

11. The beverage filter cartridge of claim 10 wherein said increased thickness is achieved by lining the lower region of said filter element with a cup-shaped insert of the same or like filter material.

12. A beverage filter cartridge comprising:
a cup-shaped outer container having a side wall and a bottom; and
a cup-shaped filter element having a side wall and a bottom; said filter element being arranged to subdivide the interior of said container into a first chamber inside said filter element and a second chamber located between the bottom of said filter element and the bottom of said container, said filter element having an upper rim joined to the container side wall at a peripheral juncture, and said filter sidewall having exterior channels that face said container side wall and that lead downwardly from said peripheral juncture to said second chamber.
